(19) United States
(12) Patent Application Publication
(10) Pub. No.: US 2018/0121106 A1
(43) Pub. Date: May 3, 2018

(54) STORAGE DEVICE AND OPERATING METHOD THEREOF

(71) Applicant: SAMSUNG ELECTRONICS CO., LTD., SUWON-SI (KR)

(72) Inventor: SEONBONG KIM, SUWON-SI (KR)

(21) Appl. No.: 15/717,991

(22) Filed: Sep. 28, 2017

(30) Foreign Application Priority Data
Oct. 31, 2016 (KR) 10-2016-0143506

(51) Int. Cl. G06F 3/06; G06F 12/1081

(52) U.S. Cl. CPC G06F 3/0611; G06F 3/0688; G06F 3/0659; G06F 2212/7201; G06F 12/1081; G06F 2212/656; G06F 3/0607

(57) ABSTRACT

An operating method of a storage device includes receiving, at a hardware read path controller, a read command, determining, at the read path controller, a match of an index corresponding to the read command, reading data corresponding to the read command from a buffer memory when the determination result indicates index hit, and reading, at the read path controller, data corresponding to the read command from a nonvolatile memory device by using a map table when the determination result indicates index miss.

### CROSS-REFERENCE TO RELATED APPLICATIONS

This U.S. non-provisional patent application claims priority under 35 U.S.C. § 119 to Korean Patent Application No. 10-2016-0143506, filed on Oct. 31, 2016 in the Korean Intellectual Property office, the entire contents of which are hereby incorporated by reference.

### BACKGROUND

Embodiments of the present disclosure relate to a storage device and an operating method thereof.

The operating speed of a host, which communicates with a storage device, is improved as semiconductor manufacturing technologies develop. A host might be, for example, a computer, a smartphone, or a smart pad, and may include the storage device or may be physically separated from the storage device. Furthermore, the size of content used in a storage device and a corresponding host device is increasing. As such, techniques are being developed to improve the operating speed of the storage device.

### SUMMARY

Embodiments of the present disclosure provide a storage device with improved read performance and an operating method thereof.

According to an aspect of an embodiment of the present disclosure, an operating method of a storage device includes receiving, at a hardware read path controller, a read command The operating method also includes determining, at the read path controller, whether the read command matches an index corresponding to the read command. Data corresponding to the read command is read from a buffer memory, based on determining that the read command matches the index. Data corresponding to the read command is read at the read path controller from a nonvolatile memory device by using a map table based on determining that the read command does not match the index.

According to another aspect of an embodiment, an operating method of a storage device includes receiving a read command, selecting a read path, which corresponds to the received read command, of multiple read paths, and reading data stored in a buffer memory through the selected read path. The read paths include a first read path, a second read path, and a third read path. The first read path includes a read path controller interpreting the read command, searching for a physical address corresponding to a logical address of the read command from a map table, reading data from a nonvolatile memory device based on the physical address, and storing the read data in the buffer memory. The second read path includes using firmware to interpret the read command, search for the physical address corresponding to the logical address of the read command from the map table, read data from the nonvolatile memory device based on the physical address, and store the read data in the buffer memory. The third read path includes reading, at the read path controller, data stored in the buffer memory based on the logical address of the read command.

According to another aspect of an embodiment of the present disclosure, a storage device includes a central processing unit, a buffer memory, a hardware read path controller, and at least one nonvolatile memory device. The central processing unit drives firmware. The buffer memory stores a map table. The read path controller selects one of a first read path, a second read path, and a third read path based on a result of determining whether an index matches address information of a read command. The first read path includes the read path controller interpreting the read command, searching for a physical address corresponding to a logical address of the read command from the map table, reading data from the at least one nonvolatile memory device based on the physical address, and storing the read data in the buffer memory. The second read path includes the firmware interpreting the read command, searching for the physical address corresponding to the logical address of the read command from the map table, reading data from the at least one nonvolatile memory device based on the physical address, and storing the read data in the buffer memory. The third read path includes reading, at the read path controller, data stored in the buffer memory based on the logical address of the read command.

According to another aspect of an embodiment, a storage device includes a read path having a first latency, a read path having a second latency, a read path having a third latency, and a read path having a fourth latency. The read path having the first latency outputs data from a buffer memory in response to a read command by firmware. The second latency is shorter than the first latency and the read path having the second latency outputs data from the buffer memory in response to a read command by a read path controller. The third latency is longer than the first latency, and the read path having the third latency outputs data from a nonvolatile memory device in response to a read command by the firmware. The fourth latency is shorter than the third latency, and the read path having the fourth latency outputs data from the nonvolatile memory device in response to a read command by the read path controller. The read path controller is hardware that interprets a received read command and searches a map table having a flash translation layer (FTL) to access the nonvolatile memory device.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a drawing illustrating a storage device, according to an embodiment of the present disclosure;

FIG. 2 is a drawing illustrating a range filter illustrated in FIG. 1;

FIG. 3 is a view illustrating a comparator illustrated in FIG. 2;

FIG. 4 is a drawing illustrating a storage device, according to another embodiment of the present disclosure;

FIG. 5 is a drawing illustrating a storage device, according to another embodiment of the present disclosure;

FIG. 6 is a flowchart illustrating a read method of a storage device, according to an embodiment of the present disclosure;

FIG. 7 is a drawing illustrating a read method of a storage device, according to another embodiment of the present disclosure;

FIG. 8 is a flowchart illustrating an operating method of a range filter of a storage device, according to an embodiment of the present disclosure;

FIG. 9 is a flowchart illustrating a read method of a storage device, according to an embodiment of the present disclosure;

FIG. 10 is a block diagram illustrating a storage device, according to another embodiment of the present disclosure;

FIG. 11 is a block diagram illustrating a storage device, according to another embodiment of the present disclosure;

FIG. 12 is a drawing illustrating a mobile device, according to an embodiment of the present disclosure;

FIG. 13 is a drawing illustrating a computing system, according to another embodiment of the present disclosure; and

FIG. 14 is a block diagram illustrating a data server system, according to an embodiment of the present disclosure.

### DETAILED DESCRIPTION

Below, embodiments of the present disclosure may be described in detail and clearly to such an extent that one of ordinary skill in the art can easily implement the teachings and concepts described herein.

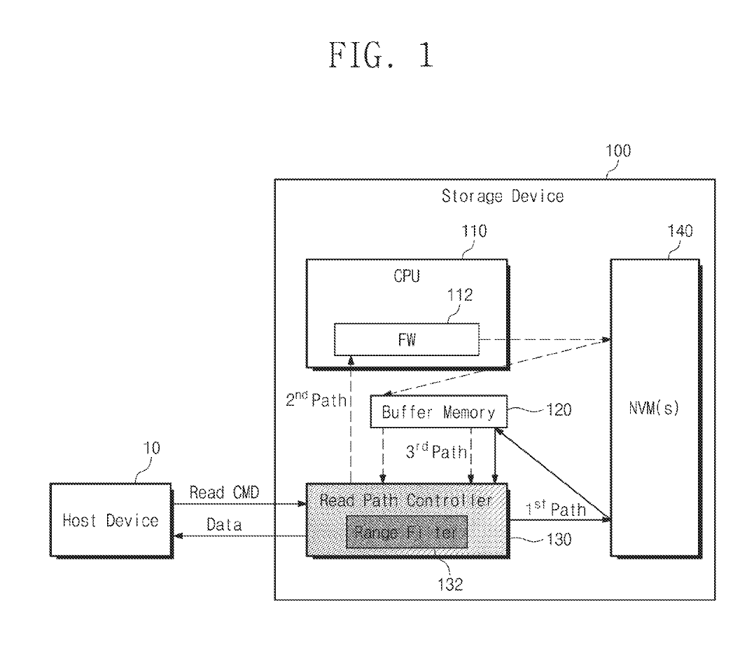

FIG. 1 is a drawing illustrating a storage device 100, according to an embodiment of the present disclosure. Referring to FIG. 1, the storage device 100 may include a central processing unit (CPU) 110, a buffer memory 120, a read path controller 130, and at least one nonvolatile memory device (NVM(s)) 140.

The CPU 110 may be implemented to control overall operations of the storage device 100. The CPU 100 may be implemented to manage the storage device 100 by using firmware (FW) 112.

The read path controller 130 may be implemented to select a read path in response to a read command received from a host device 10. As illustrated in FIG. 1, the storage device 100 may include at least three read paths: a first read path, a second read path, and a third read path. The first read path may be a path for reading data corresponding to a read command from the nonvolatile memory device 140, at the read path controller 130. The second read path may be a path for reading data corresponding to the read command from the nonvolatile memory device 140, at firmware FW 112 or software SW (for descriptive convenience, hereinafter referred to also as “FW”). The third read path may be a path for reading data corresponding to the read command directly from the buffer memory 120, at the read path controller 130.

In an embodiment, the read path controller 130 may be implemented to be selectively activated or deactivated by the CPU 110. That is, the read path controller 130 may be implemented to interpret a read command without intervention of the firmware FW 112, to search for a physical address corresponding to a logical address included in the read command by using a mapping table, to read data, which corresponds to the physical address, from the nonvolatile memory device 140, to store the read data in the buffer memory 120, and to output the data stored in the buffer memory 120 to the host device 10. Here, the mapping table may be loaded in the buffer memory 120 while the storage device 100 is initialized.

Stated differently, the read path controller 130 may be pre-authorized, such as by the CPU 110, to interpret a read command without requiring the firmware FW 112 of the CPU 110. During initialization, the mapping table may be loaded in the buffer memory 120 while the storage device 100 is initialized, and then used by the read path controller 130 when read commands are received. The read path controller 130 reduces any burden on CPU 110, or the firmware FW 112 of the CPU 110, imposed by handling/processing read commands. Additionally, as explained below, the mapping table can be used to identify a physical address of the nonvolatile memory device 140 to retrieve data when the read path controller 130 determines that the data is, for example, not in the buffer memory 120.

In an embodiment, the read path controller 130 may be implemented to include a range filter 132. The range filter 132 may be implemented to determine hit/miss by comparing an address included in a read command with indexes that are stored in advance. Here, each index may include an address corresponding to data stored in the buffer memory 120.

When the addresses agree with each other, that is, when the hit occurs, a read operation corresponding to the read command may be directly performed on the buffer memory 120 by the read path controller 130. When the addresses are different from each other, that is, when the miss occurs, the read operation corresponding to the read command may be performed by the read path controller 130 without intervention of the firmware FW 112 or by the firmware FW 112. That is, even when the check of the address by the read path controller 130 does not result in a determination that the sought data is stored in the buffer memory 120, the read path controller 130 can still retrieve the data without specifically requiring intervention of or processing by the CPU including the firmware FW 112. In an embodiment, whether a read operation accompanies the intervention of the firmware FW 112 may be determined by one or more of conditions such as sequential read, the size of data to be read, and data hazard. Here, the data hazard may be when write data for a write operation is present in the buffer memory 120.

For example, in the case of a prefetch read operation, data that is prefetched through the second read path may be stored in the buffer memory 120. Afterwards, the range filter 132 may store at least one index including a, for example logical, address corresponding to the prefetched data.

According to an embodiment of the present disclosure, the storage device 100 may determine index match using hardware such as the read path controller 130, thus preventing collision of read operations through different read paths, and thus improving a read speed.

According to an embodiment of the present disclosure, the storage device 100 may include the range filter 132 for selecting a read path, thus improving a speed of a read operation and reliability.

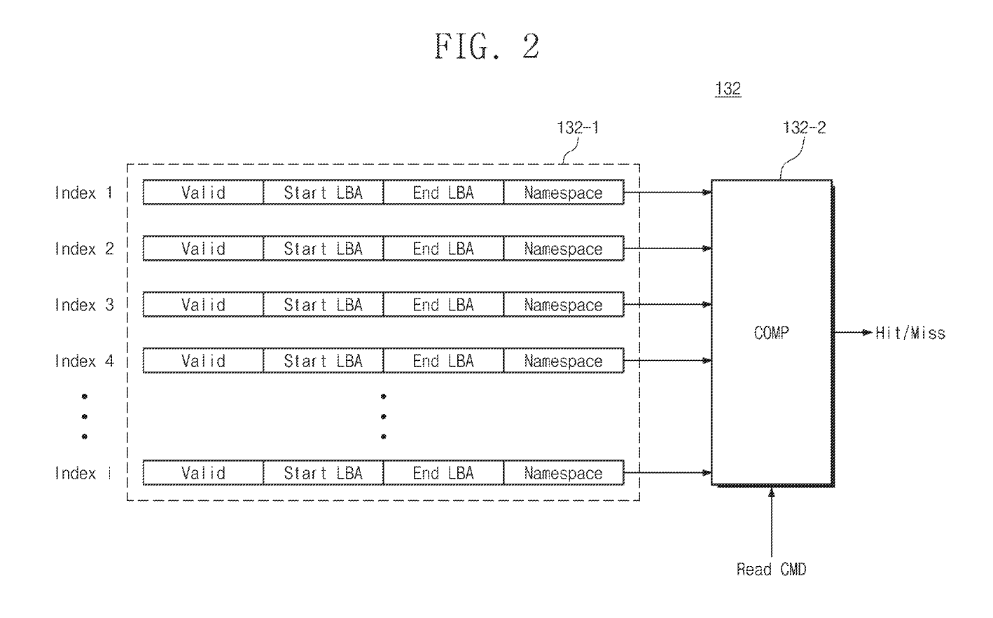

FIG. 2 is a drawing illustrating the range filter 132 illustrated in FIG. 1. Referring to FIG. 2, the range filter 132 may include multiple register sets 132-1 and a comparator 132-2.

The register sets 132-1 may be implemented to store indexes Index 1 to Index i (i being an integer of 2 or more) under control of the CPU 110 (refer to FIG. 1), respectively. Here, each index may include information about whether an index is valid, a start logical address, an end logical address, and namespace information. Each index may include address information associated with, for example, a logical address of data stored in the buffer memory 120.

In an embodiment, a read command that is received from the host device 10 (refer to FIG. 1) may include a start logical address, an end logical address, namespace information.

The comparator 132-2 may be implemented to compare address information of each index with address information of the received read command and output hit/miss as the comparison result.

It should be understood that the configuration of each index illustrated in FIG. 2 is only an embodiment not limiting the scope and spirit of the present disclosure. The index may be implemented to store address information in various schemes.

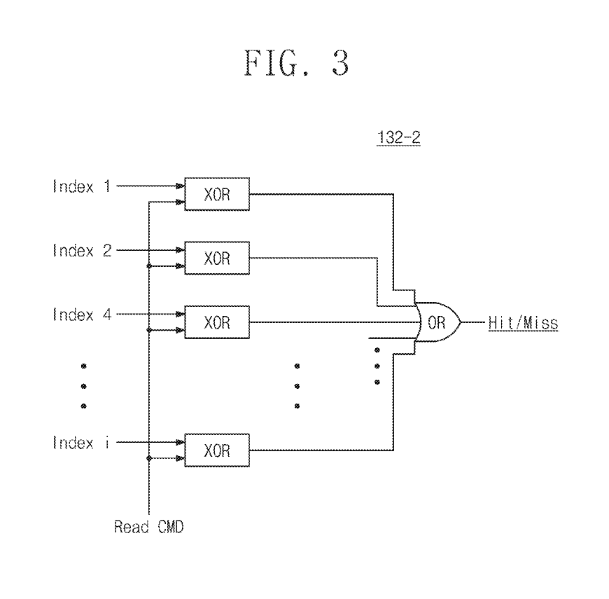

FIG. 3 is a drawing illustrating the comparator 132-2 illustrated in FIG. 2. Referring to FIG. 3, the comparator 132-2 may include multiple exclusive OR (XOR) logic circuits (first logic circuits) and an OR logic circuit (second logic circuit).

Each of the XOR logic circuits may be implemented to perform an XOR operation on the corresponding one of the indexes Index 1 to Index i and the address information of the read command.

The OR logic circuit may be implemented to perform an OR operation on output values of the XOR logic circuits. Here, an output value of the OR logic circuit may be a value that indicates index hit or index miss.

The configuration of the comparator 132-2 illustrated in FIG. 3 is only an embodiment not limiting the scope and spirit of the present disclosure. The comparator 132-2 may be implemented in various schemes.

According to an embodiment of the present disclosure, the storage device 100 may further include an error correction circuit.

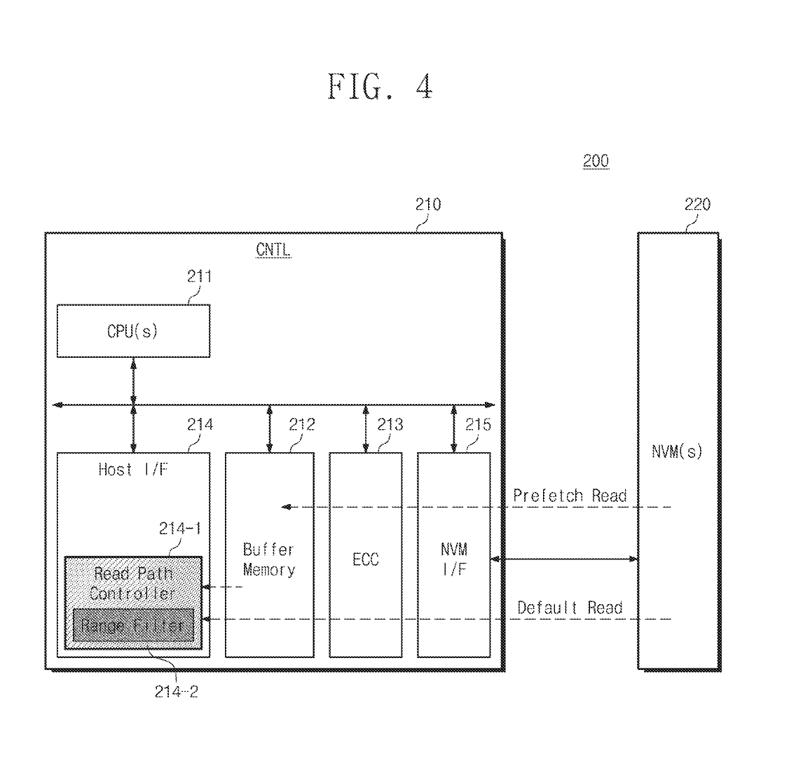

FIG. 4 is a drawing illustrating a storage device 200, according to another embodiment of the present disclosure. Referring to FIG. 4, the storage device 200 may include at least one nonvolatile memory device (NVM(s)) 210 and a controller 220 that controls the nonvolatile memory device 210.

The nonvolatile memory device 210 may be implemented to store data. The nonvolatile memory device 210 may be a NAND flash memory, a vertical NAND flash memory (VNAND), a NOR flash memory, a resistive random access memory (RRAM), a phase change memory (PRAM), a magneto-resistive random access memory (MRAM), a ferroelectric random access memory (FRAM), a spin transfer torque random access memory (STT-RAM), or the like.

Furthermore, the nonvolatile memory device may be implemented to have a three-dimensional (3D) array structure. In an embodiment of the present disclosure, a 3D memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The circuit related on an operation of memory cells may be located in a substrate or on a substrate. The term “monolithic” means that layers of each level of the array are directly deposited on the layers of each underlying level of the array.

In an embodiment of the present disclosure, the 3D memory array includes vertical NAND strings that are vertically oriented such that at least one memory cell is located over another memory cell. The at least one memory cell may comprise a charge trap layer. Each vertical NAND string may include at least one selection transistor located over memory cells. At least one selection transistor may have the same structure as those of memory cells and may be monolithically formed together with memory cells.

The three-dimensional memory array is formed of multiple levels and has word lines or bit lines shared among levels. The following patent documents, which are hereby incorporated by reference, describe suitable configurations for three-dimensional memory arrays, in which the three-dimensional memory array is configured as multiple levels, which is applied by Samsung Electronics Co., with word lines and/or bit lines shared between levels: U.S. Pat. Nos. 7,679,133; 8,553,466; 8,654,587; 8,559,235; and US Pat. Pub. No. 2011/0233648. The nonvolatile memory according to an exemplary embodiment of the present disclosure may be applicable to a charge trap flash (CTF) in which an insulating layer is used as a charge storage layer, as well as a flash memory device in which a conductive floating gate is used as a charge storage layer.

The controller 220 may include at least one CPU, a buffer memory, an error correction circuit (ECC), a host interface (HIF), and a nonvolatile memory interface (NIF).

The buffer memory may be implemented to temporarily store data, which is needed for an operation of the controller. For example, in FIG. 4, the buffer memory may be arranged within the controller 220. However, embodiments of the present disclosure may not be limited thereto. The buffer memory may be arranged on the outside of the controller 220. In an embodiment, the buffer memory may be a random access memory (RAM), a static random access memory (SRAM), a phase-change random access memory (PRAM), etc.

The error correction circuit may calculate a value of an error correction code of data to be programmed in a write operation, may correct data read in a read operation based on the value of the error correction code, and may correct an error of data recovered from the nonvolatile memory device 210 in a data recovery operation. The error correction circuit may generate an error correction code ECC for correcting a fail bit or error bit of data received from the nonvolatile memory device 210. Also, the error correction circuit may generate data, to which a parity bit(s) is added, by performing error correction encoding on data to be provided to the nonvolatile memory device 210. The parity bit may be stored in the nonvolatile memory device 210. Moreover, the error correction circuit may perform error correction decoding on data output from the nonvolatile memory device 210.

The error correction circuit may be implemented to correct an error by using parity information. The error correction circuit may correct an error by using coded modulation such as a low density parity check (LDPC) code, a Bose, Chaudhuri, Hocque-nghem (BCH) code, a turbo code, a Reed-Solomon code, a convolution code, a recursive systematic code (RSC), a trellis-coded modulation (TCM), or a block coded modulation (BCM).

Although not illustrated in FIG. 4, a code memory that stores code data needed to operate the controller 220 may be further included in the controller 220. The code memory may be implemented with a nonvolatile memory device.

The host interface may be implemented to provide an interface function for interfacing with an external device. The host interface may be connected with the host device 10 (refer to FIG. 1) through a communication interface: non-volatile memory express (NVMe), peripheral component interconnect express (PCIe), serial at attachment (SATA), small computer system interface (SCSI), serial attached SCSI (SAS), universal storage bus (USB) attached SCSI (UAS), Internet small computer system interface (iSCSI), fiber channel, or fiber channel over Ethernet (FCoE).

The host interface may include a read path controller described with reference to FIGS. 1 to 3. The read path controller may be implemented to include a range filter.

The nonvolatile memory interface (NIF) may provide an interface function for interfacing with nonvolatile memory device 210. The subject that controls the nonvolatile memory interface in a read operation may be any one of firmware FW of the CPU and the read path controller.

In an embodiment, a default read operation may include reading data from the nonvolatile memory device 210 without intervention of the firmware FW, correcting an error of the read data, and outputting the corrected data to the outside through the buffer memory, at the read path controller.

In an embodiment, a prefetch read operation may include reading data from the nonvolatile memory device 210 in advance, correcting an error of the read data, and storing the corrected data in the buffer memory, and then, may include outputting the data stored in the buffer memory to the outside, at firmware FW. The firmware FW may be implemented to manage the buffer memory, for the prefetch operation.

In an embodiment, the range filter may be implemented to store, when data is stored in the buffer memory for the prefetch operation, indexes corresponding to the data stored by the firmware FW.

According to an embodiment of the present disclosure, the storage device 100 may further include a direct memory access (DMA) circuit.

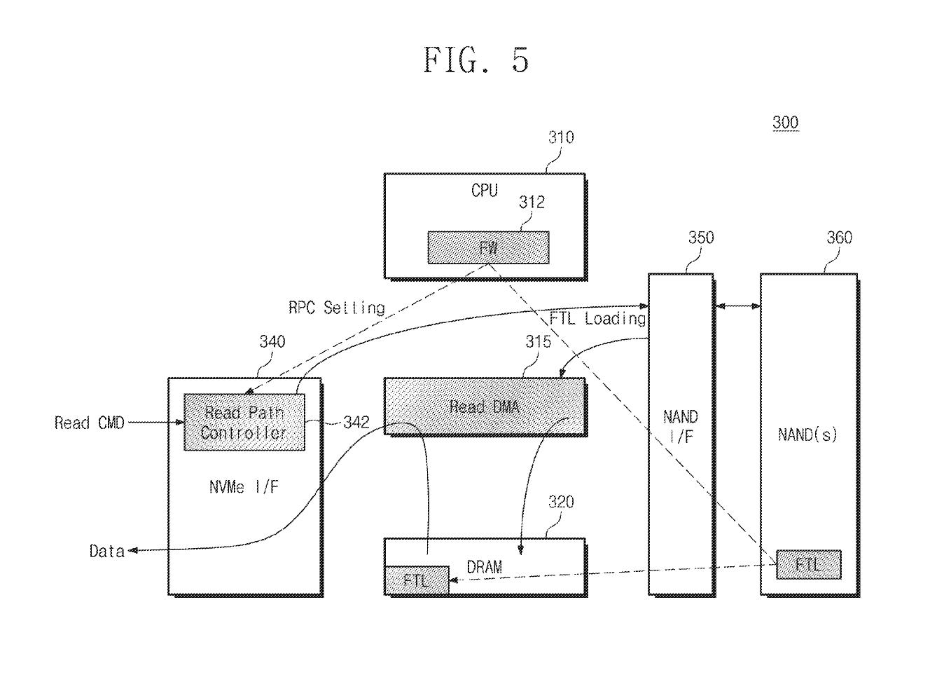

FIG. 5 is a drawing illustrating a storage device 300, according to another embodiment of the present disclosure. Referring to FIG. 5, the storage device 300 may include a CPU 310, a read DMA circuit 315, a DRAM 320, an NVMe interface 340, a NAND interface 350, and at least one NAND flash memory device 360.

In an initialization operation of the storage device 300, firmware FW 312 may set whether to activate a read path controller 342 and may load a flash transition layer FTL in the DRAM 320. Afterwards, if a read command is received from the host device 10, the read path controller 342 may interpret the received read command and may control the NAND interface 350 to perform a read operation, which corresponds to a physical address corresponding to the read command, by using the FTL loaded in the DRAM 320. The NAND interface 350 may read data from the NAND flash memory device 360 in response to the interpreted read command and may transmit the read data to the read DMA circuit 315. The read DMA circuit 315 may transmit the received data to the DRAM 320 that is used as buffer memory. Afterwards, the read path controller 342 may output the data stored in the buffer memory 320 to the host device 10.

Unlike the above-described read operation, the firmware 312 may interpret a read command and may control the NAND interface 350 by using the FTL in the DRAM 320.

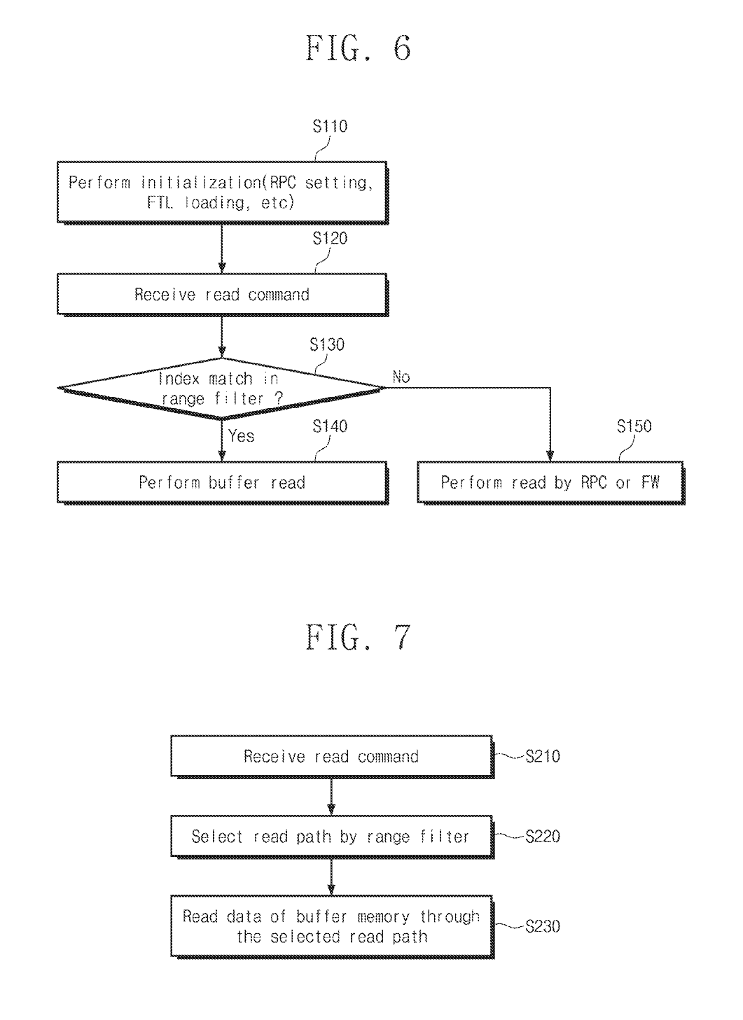

FIG. 6 is a flowchart illustrating a read method of a storage device, according to an embodiment of the present disclosure. A read operation of a storage device will be described with reference to FIGS. 1 to 6.

An initialization operation may be performed in a storage device. Here, the initialization operation may include loading metadata (e.g., FTL) needed for a hardware setting operation (e.g., setting a read path controller) and management in a buffer memory (S110). Afterwards, a read command may be received from a host device (S120). A range filter of the read path controller may determine whether address information of the read command is included in address information stored in indexes. That is, index match may be determined (S130). For example, a logical address provided via the read command may be compared with addresses stored in the indexes. A match is confirmed when the logical address is matched with an address stored in the index.

When the index match occurs, the match may indicate that data corresponding to the read command is stored in the buffer memory. In this case, buffer read may be performed to read data corresponding to the read command from the buffer memory (S140). The data may be read using, for example, a logical address provided via the read command.

In contrast, when the index miss occurs, the miss may indicate that data corresponding to the read command is not stored in the buffer memory. In an embodiment, the read path controller may interpret the read command and may read data corresponding to the interpreted read command from the nonvolatile memory device. In another embodiment, firmware may interpret the read command and may read data corresponding to the interpreted read command from the nonvolatile memory device (S150).

According to an embodiment of the present disclosure, based on the index match/miss, the storage device may perform direct buffer read or indirect buffer read. The direct buffer read involves directly reading the corresponding data from the buffer memory. The indirect buffer read involves reading the corresponding data directly from a nonvolatile memory device.

FIG. 7 is a drawing illustrating a read method of a storage device, according to another embodiment of the present disclosure. A read operation of a storage device will be described with reference to FIGS. 1 to 5 and 7.

A read command may be received from a host device (S210). The read command may be a sequential read command or a random read command. An optimum read path corresponding to the read command may be selected by a range filter of a read path controller (S220). For example, in the case of the sequential read command, a read path for the prefetch read operation may be selected. In the case of the random read command, a read path by the read path controller may be selected. The types of read paths described above may be used to determine whether intervention of CPU/FW/SW is required. The read path controller may read data corresponding to the read command from a buffer memory through the selected read path (S230).

According to an embodiment of the present disclosure, a read operation of a storage device may have a first latency corresponding to an access to a buffer memory in the case of the prefetch operation, and a second latency corresponding to a random read operation without intervention of the firmware FW. Here, the second latency may be longer than the first latency and may be shorter than a third latency corresponding to a read path in which the firmware FW intervenes, (e.g., is required).

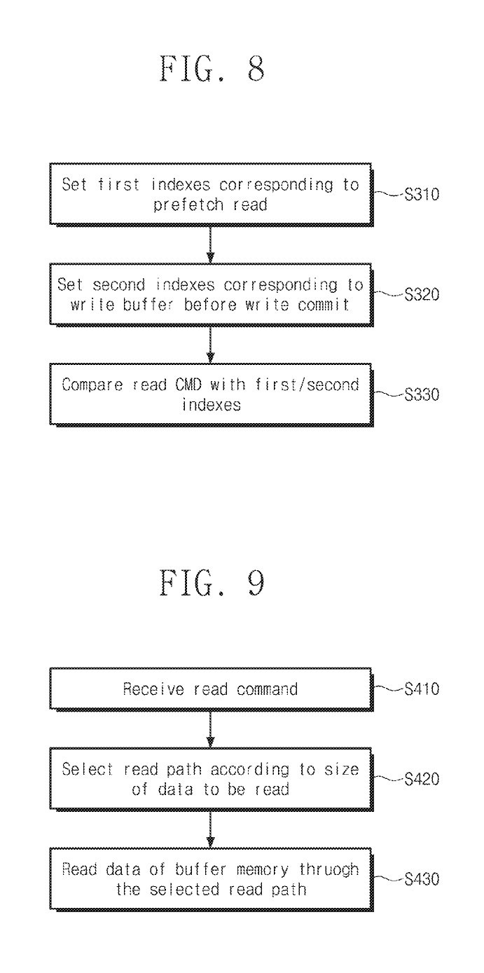

FIG. 8 is a flowchart illustrating an operating method of a range filter of a storage device, according to an embodiment of the present disclosure. An operating method of the range filter will be described with reference to FIGS. 1 to 8.

The firmware FW may manage the prefetch read operation. If the prefetch read operation is performed, data may be loaded in advance from a nonvolatile memory device to a buffer memory. In this case, the firmware FW may set first indexes corresponding to the prefetch read operation in the range filter (S310). Here, the index setting may be the same as that illustrated in FIG. 2.

Also, the firmware FW may manage a write operation. According to the write operation, write data may be written in the nonvolatile memory device after being first stored in the buffer memory. Write commit may be issued after the write data is written in the nonvolatile memory device. If the write data is stored in the buffer memory, the firmware FW may set second indexes corresponding to the write data in the range filter (S320). In an embodiment, the second indexes may be valid before the write commit In another embodiment, the second indexes may be valid even after the write commit

Afterwards, if a read command is received, the range filter may compare the read command and the first and second indexes and may output index match/miss based on the comparison result (S330).

In an embodiment illustrated in FIG. 8, the operations from S310 to S330 are sequential. However, embodiments of the present disclosure may not be limited thereto. It should be understood that operation S310 to operation S330 may progress in different, or even arbitrary, order and an additional operation may be performed.

According to another embodiment of the present disclosure, the storage device may select a read path based on the size of data.

FIG. 9 is a flowchart illustrating a read method of a storage device, according to an embodiment of the present disclosure. A read operation of a storage device will be described with reference to FIGS. 1 to 5 and 9.

A read path controller may receive a read command from the host device 10 (S410). The read path controller may decode the read command A read path may be selected according to the size of to-be-read data, which is determined based on the decoded read command (S420). For example, if the size of data is not less than a predetermined value, a read path in which the firmware FW intervenes may be selected. In contrast, if the size of data is smaller than the predetermined value, a read path in which the read path controller directly accesses the nonvolatile memory device without intervention of the firmware FW may be selected. Afterwards, data stored in the buffer memory through the selected read path may be output as read data (S430).

According to the above-described read operation, it may be possible to read and output data through a read path that is variable with the size of data to be read.

The storage device may include different read paths that are selected according to whether there is a need for intervention of the firmware FW.

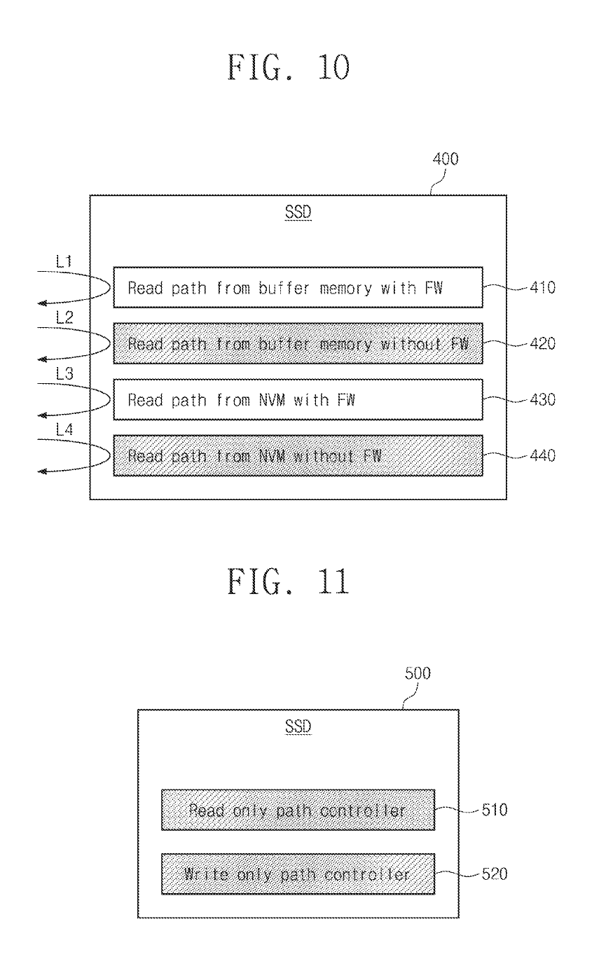

FIG. 10 is a block diagram illustrating a storage device, according to another embodiment of the present disclosure. Referring to FIG. 10, a storage device (SSD) 400 may include a read path 410, a read path 420, a read path 430 and a read path 440. In the read path 410 data is read from a buffer memory under intervention of firmware FW. In the read path 420 data is read from the buffer memory without intervention of the firmware FW. In the read path 430 data is read from a nonvolatile memory NVM under intervention of the firmware FW. In the read path 440 data is read from the nonvolatile memory NVM without intervention of the firmware FW.

In an embodiment, a latency L2 of the read path 420 may be shorter than a latency L1 of the read path 410.

In an embodiment, a latency L3 of the read path 430 may be longer than the latency L1 of the read path 410. Also, the latency L3 of the read path 430 may be longer than the latency L2 of the read path 420.

In an embodiment, a latency L4 of the read path 440 may be shorter than the latency L3 of the read path 430. Also, the latency L4 of the read path 440 may be longer than the latency L2 of the read path 420.

According to another embodiment of the present disclosure, the storage device includes a read only path and a separate write only path.

FIG. 11 is a block diagram illustrating a storage device, according to another embodiment of the present disclosure. Referring to FIG. 11, a storage device 500 may include a read only path controller 510 and a write only path controller 520. The read only path controller 510 may be implemented to perform a read operation without intervention of firmware FW. Also, the write only path controller 520 may be implemented to perform a write operation under intervention of the firmware FW.

Embodiments of the present disclosure may be applicable to a mobile device.

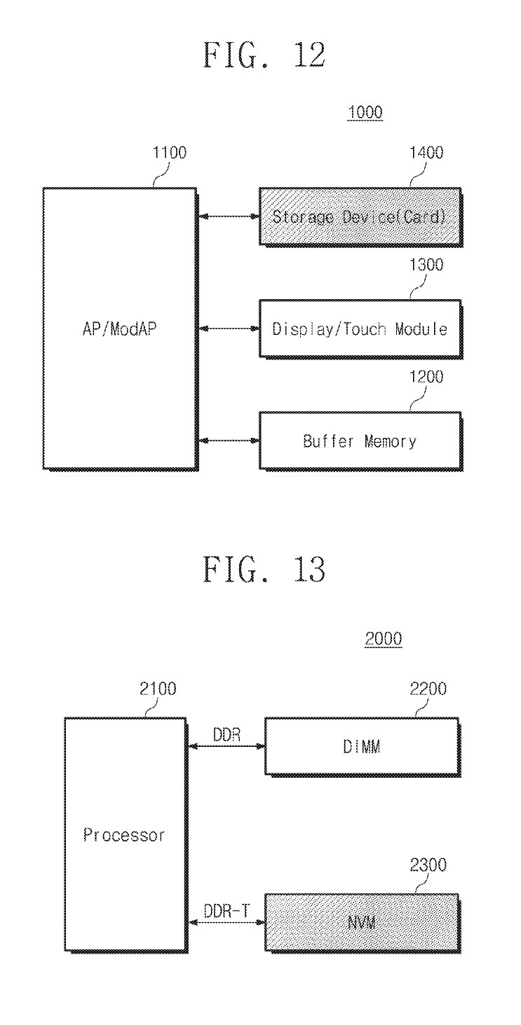

FIG. 12 is a block diagram illustrating a mobile device 1000, according to an embodiment of the present disclosure. Referring to FIG. 12, the mobile device 1000 may include a processor (AP/ModAP) 1100, a buffer memory 1200, a display/touch module 1300, and a storage device 1400.

The processor 1100 may be implemented to control overall operations of the mobile device 1000 and wired/wireless communication with an external device. For example, the processor 1100 may be an application processor (AP), an integrated modem application processor (ModAP), etc.

The processor 1100 may include authentication agent, trusted execution environment (TEE), and a secure chip. The secure chip may be implemented with software and/or tamper resistant hardware, may permit high-level security, and may operate in conjunction with trusted execution environment (TEE) of the processor 1100. For example, the secure chip may perform an encryption and decryption operation, MAC key generation/verification, etc. in the TEE. The secure chip may include a Native operating system (OS), a secure storage device that is internal data storage, an access control block that controls authority to access the secure chip, a secure function block that performs ownership management, key management, digital signature, encryption/decryption, etc., and a firmware update block that updates firmware of the secure chip. The secure chip may be a universal IC card (UICC) (e.g., USIM, CSIM, and ISIM), a subscriber identity module (SIM) card, embedded secure elements (eSE), a microSD, Stickers, etc.

The buffer memory 1200 may be implemented to temporarily store data, which is needed for a processing operation of the mobile device 1000. In an embodiment, the buffer memory 1200 may be implemented with a DRAM, an SRAM, an MRAM, etc. The buffer memory 1200 may include a non-encryption data area and an encryption data area. Here, the encryption data area may store data that are encrypted by the secure chip.

The display/touch module 1300 may be implemented to display data processed by the processor 1100 or to receive data from a touch panel.

The storage device 1400 may be implemented to store data of a user. The storage device 1400 may be an embedded multimedia card (eMMC), a solid state drive (SSD), a universal flash storage (UFS), etc. The storage device 1400 may include a storage device described with reference to FIGS. 1 to 11.

According to an embodiment of the present disclosure, the mobile device 1000 may change a read path based on an environment such as a data type/an input/output situation, thus optimizing a read latency.

According to an embodiment of the present disclosure, a storage device may be used as a main memory.

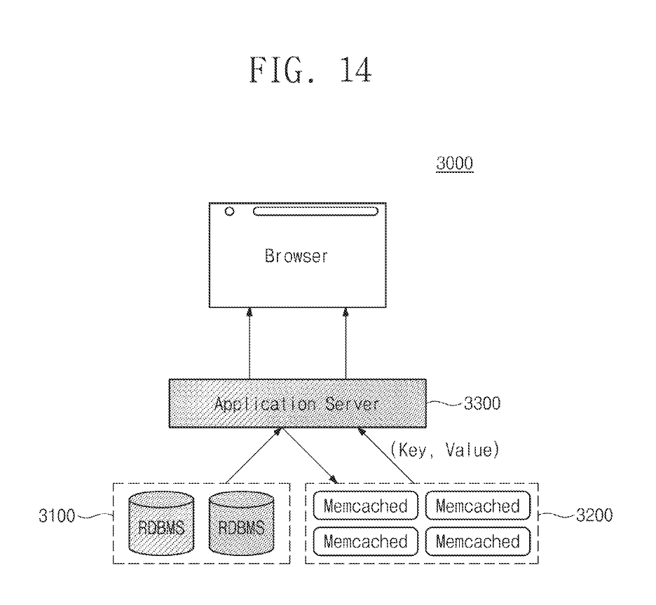

FIG. 13 is a drawing illustrating a computing system 2000, according to another embodiment of the present disclosure. Referring to FIG. 13, the computing system 2000 may include a processor 2100, a memory module (DIMM) 2200, and a nonvolatile memory (NVM) 2300.

The memory module 2200 may be connected to the processor 2100 through a DDR interface. The memory module 2200 may be implemented to perform a cache function of the nonvolatile memory 2300.

The nonvolatile memory 2300 may input and output data based on the DDR-T (transaction) interface. In this case, in an embodiment, the nonvolatile memory 2300 may be a 3D-Xpoint memory. The nonvolatile memory 2300 may be implemented with a storage device described with reference to FIGS. 1 to 11.

According to an embodiment of the present disclosure, a storage device may be applicable to a data server.

FIG. 14 is a block diagram illustrating a data server system 3000, according to an embodiment of the present disclosure. Referring to FIG. 14, the data server system 3000 may include a relational database management system (RDBMS) 3100, a cache server 3200, and an application server 3300.

The cache server 3200 may be implemented to maintain and delete different key and value pairs in response to an invalidation notification from the relational database management system 3100. At least one of the related database management system 3100, the cache server 3200, and the application server 3300 may be implemented with a storage device described with reference to FIGS. 1 to 11.

According to an embodiment of the present disclosure, a storage device may include a hardwired NAND read path. Here, the hardwired NAND read path may be a series of paths for interpreting, at hardware, a command without any intervention of internal firmware/software (FW/SW) of a device to improve the performance of low latency read, searching a map (a table for mapping logic block addresses (LBAs) and physical NAND addresses), reading data from a NAND memory device, sending the read data to a host, and sending completion to the host, when the host issues a read command.

According to an embodiment of the present disclosure, for optimum performance of the row latency read, a storage device may include hardware (e.g., a range filter) for preventing collision with a NAND read operation on the same LBA due to a prefetch read operation in the hardwired NAND read path without firmware FW intervention. When the storage device receives a read command from the host with regard to a specific LBA on which prefetch is currently performed, the storage device may directly send data from a buffer memory without a duplicated NAND read by the hardwired NAND read path, thus improving a latency or throughput.

Since the firmware FW registers a prefetch area at the range filter in a prefetch operation, the storage device may directly send prefetched data from the buffer memory without a duplicated NAND read request on LBA being prefetched in the hardwired NAND read path, thus improving a latency or throughput.

In the case of the hardwired NAND read path in which the range filter is present, range information of an LBA being prefetched through a software NAND read path may be registered at the range filter. Afterwards, when the storage device receives a read command for the same LBA from the host, the storage device may send prefetched data from the buffer memory without a duplicated read operation on the NAND memory device.

According to an embodiment of the present disclosure, an operating method of a range filter may include validating the corresponding index by inputting, by firmware, a namespace identifier, a start logical block address (start LBA), and an end logical block address (end LBA) of an area (e.g., a prefetch area), of which a hardwired NAND read path is blocked, to a specific index; receiving, by the range filter, an LBA value of a read command of a host; and not operating the hardwired NAND read path when a result of comparing an LBA area input to each index and an LBA value of the read command of the host indicates that the LBA value of the read command of the host matches an area registered at the range filter.

According to embodiments of the present disclosure, an index match may be determined in a hardware scheme, thus preventing collision between read operations of different read paths and improving a read speed.

While the present disclosure has been described with reference to exemplary embodiments, it will be apparent to those skilled in the art that various changes and modifications may be made without departing from the spirit and scope of the present disclosure. Therefore, it should be understood that the above embodiments are not limiting, but illustrative.

1. An operating method of a storage device, the method comprising:
receiving, at a hardware read path controller, a read command;
determining, at the read path controller, whether the read command matches an index corresponding to the read command;
reading data corresponding to the read command from a buffer memory based on determining that the read command matches the index; and
reading data corresponding to the read command from a nonvolatile memory device by using a map table based on determining that the read command does not match the index.

2. The method of claim 1, further comprising:
setting, at firmware, whether to activate the read path controller in an initialization operation.

3. The method of claim 1, further comprising:
loading, at firmware, the map table in the buffer memory in an initialization operation.

4. The method of claim 1, further comprising:
interpreting, at the read path controller, the read command; and
searching for a physical address corresponding to a logical address of the read command from the map table.

5. The method of claim 1, wherein the read path controller comprises a plurality of indexes each indicating a different address corresponding to data stored in the buffer memory, and
wherein the method further comprises:
setting, at firmware, the plurality of indexes.

6. The method of claim 5, wherein the plurality of indexes comprise one or more first indexes, and
wherein the method further comprises:
setting, at the firmware, the one or more first indexes corresponding to a prefetch read operation.

7. The method of claim 5, wherein the plurality of indexes comprise one or more second indexes, and
wherein the method further comprises:
setting, at the firmware, the one or more second indexes when write data is present in the buffer memory.

8. The method of claim 5, wherein each of the plurality of indexes comprises validation information thereof.

9. The method of claim 1, wherein when a size of data corresponding to the read command is less than a predetermined value, the read path controller reads the data corresponding to the read command from the nonvolatile memory device in a read access by using the map table.

10. The method of claim 9, wherein when the size of the data corresponding to the read command is not less than the predetermined value, firmware reads the data corresponding to the read command from the nonvolatile memory device in a read access using the map table.

11. The method of claim 10, wherein a latency of a read access that is performed by the read path controller is shorter than a latency of a read access that is performed by the firmware.

12. The method of claim 1, wherein data read from the nonvolatile memory device is sent to the buffer memory through a direct memory access (DMA) circuit.

13. An operating method of a storage device, the method comprising:
receiving a read command;
selecting a read path, which corresponds to the received read command, of a plurality of read paths; and
reading data stored in a buffer memory or in a nonvolatile memory device through the selected read path,
wherein the plurality of read paths include a first read path, a second read path, and a third read path,
wherein the first read path includes a read path controller interpreting the read command, searching for a physical address corresponding to a logical address of the read command from a map table, reading data from the nonvolatile memory device based on the physical address, and storing the read data in the buffer memory,
wherein the second read path includes using firmware to interpret the read command, search for the physical address corresponding to the logical address of the read command from the map table, read data from the nonvolatile memory device based on the physical address, and store the read data in the buffer memory, and
wherein the third read path includes reading, at the read path controller, data stored in the buffer memory based on the logical address of the read command.

14. The method of claim 13,
wherein the read path controller comprises hardware, and
wherein the selecting the read path comprises:
determining, at a range filter of the read path controller, whether the read command matches an index by comparing the logical address of the read command with each of a plurality of indexes.

15. The method of claim 13, wherein the selecting the read path comprises:
selecting the read path based on a size of data corresponding to the read command.

16-17. (canceled)

18. A storage device, comprising:
a central processing unit configured to drive firmware;
a buffer memory configured to store a map table;
a hardware read path controller configured to select one of a first read path, a second read path, and a third read path based on a result of determining whether an index matches address information of a read command; and
at least one nonvolatile memory device,
wherein the first read path includes the read path controller interpreting the read command, searching for a physical address corresponding to a logical address of the read command from the map table, reading data from the at least one nonvolatile memory device based on the physical address, and storing the read data in the buffer memory,
wherein the second read path includes the firmware interpreting the read command, searching for the physical address corresponding to the logical address of the read command from the map table, reading data from the at least one nonvolatile memory device based on the physical address, and storing the read data in the buffer memory, and
wherein the third read path includes reading, at the read path controller, data stored in the buffer memory based on the logical address of the read command.

19. The storage device of claim 18, wherein the read path controller comprises:
a range filter configured to determine whether the index matches the address information of the read command,
wherein the range filter comprises:
a register configured to store a plurality of indexes; and
a comparator configured to determine an index match or an index miss by comparing the address information of the read command with address information included in each of the plurality of indexes, and
wherein each of the plurality of indexes comprises logical address information corresponding to data stored in the buffer memory.

20. The storage device of claim 19, wherein each of the plurality of indexes comprises:
validity information indicating whether the corresponding index is valid, a start logical address, an end logical address, and namespace information.

21. The storage device of claim 19, wherein the comparator comprises:
first logic circuits configured to perform XOR operations on logical address information of each of the plurality of indexes and the logical address information of the read command; and
a second logic circuit configured to perform an OR operation on output values of the first logic circuits.

22. (canceled)

23. The storage device of claim 18, further comprising:
a read direct memory access (DMA) circuit configured to allow the read path controller or the firmware to perform a read access to the at least one nonvolatile memory device.

24-30. (canceled)
